(19) United States
(12) Patent Application Publication
(10) Pub. No.: US 2017/0220742 A1
(43) Pub. Date: Aug. 3, 2017

(54) NETWORK-BASED SYSTEMS AND METHODS FOR PROVIDING THIRD-PARTY UPDATING FOR HEALTHCARE COMMUNICATIONS

(71) Applicant: Audacious Inquiry, Catonsville, MD (US)

(72) Inventors: Sandeep Antony, Columbia, MD (US); Scott Afzal, Washington, DC (US); Evan Carter, Washington, DC (US); Christopher Brandt, Baltimore, MD (US); Yedong Tang, Columbia, MD (US)

(21) Appl. No.: 15/010,142

(22) Filed: Jan. 29, 2016

(51) Int. Cl. G06F 19/00

(52) U.S. Cl. CPC G06F 19/322

(57) ABSTRACT

Networks and methods include computers that receive electronic healthcare information from a provider, identify a patient in the received information, and address and deliver an update to the patient and/or a related party. The address is determined from a database that includes information for the patients, including internal, governmental, and proprietary private databases. The update may be delivered along with a healthcare alert to subscribing parties, such that a patient will be made aware that their healthcare information has been shared and related parties can take action with regard to the patient. The update is customizable with any information from the healthcare information and databases and information from subscribing parties and can be further customized based on the addressee. The update can be generated in real-time or following a delay and delivered via any electronic or hard-copy means by the computer.

### BACKGROUND

Healthcare information, including patient medical records and activities, facility encounters, insurance information, provider institutions, billing data, government healthcare support information, etc., across a large population can be aggregated in a Health Information Exchange (HIE) or similar database. For example, providers, insurers, and/or or governmental bodies may gather relevant healthcare information for all patients, providers, insurers, and other healthcare actors in HIEs. Because of the timing of healthcare information generation, the number of independent actors involved in healthcare administration, and privacy/proprietary aspects of healthcare information, HIEs may be largely computerized and operate with large degrees of autonomy and scalability to communicate amongst several independent users. HIEs may further employ healthcare information standards that permit reliable and secure exchange of healthcare information for millions of patients and users. An example of a related art HIE may be Maryland's CRISP network and associated Master Patient Index (MPI).

FIG. 1 is an illustration of a related health information exchange system 10. As shown in FIG. 1, system 10 includes a HIE 15 having a healthcare information routing and demographic matching structure 30, healthcare information database 21, and a healthcare information logic structure 20. Healthcare information routing and demographics matching structure 30 may be a digitized or computer-based system that facilitates entry, gathering, and organization of healthcare information from one or more providers 50.

For example, providers 50 may be emergency rooms, outpatient clinics, urgent care offices, pharmacies, laboratories, assisted living facilities, visiting nurse networks, etc. Providers 50 are conventionally the only source of healthcare information for HIE 15, acquired via healthcare information routing and demographics matching structure 30. For example, a provider 50 may provide clinical feeds 36, patient Admit-Discharge-Transfer (ADT) messages 35 in a known HL7 standard format, and/or any other healthcare information to healthcare information routing and demographics matching structure 30. The healthcare information, including content from clinical feeds 36 and ADT messages 35, may include many different types of relevant healthcare information, like patient biographical information, clinical treatment information, medical history, insurance information, provider activities, lab results, charges for services, emergency contacts, next of kin, etc. as well as nonclinical data like administrative codes, provider system IDS, etc. that typically reflect healthcare information on a per patient and/or per transaction basis. Particularly, ADT messages 35 may be generated and transmitted any time a patient has an encounter with a hospital 50, such as an admittance, discharge, transfer, to/from/within a hospital, and ADT messages 35 include this encounter information.

As shown in FIG. 1, healthcare information routing and demographics matching structure 30 may include an interface or router 32 that receives clinical feeds 36 and/or ADT messages 35 from hospitals 50. The router 32 may process or otherwise prepare data for entry into a database 21 and associated master patient index 31, which matches patient identifying information with content of database 21 to reconcile patient identity within health information exchange 15.

Conventionally, while only healthcare providers 50 deliver healthcare information to HIE 15, subscribing entities 60 may access healthcare information stored in database 21 of HIE 15. The healthcare information may be indexed by master patient index 31 and accessed through healthcare information logic structure 20 in health information exchange 15 that is interfaced with healthcare information routing and demographics matching structure 30. Subscribers 60 may be, for example, physicians needing comprehensive healthcare information regarding patients who present at urgent care or offices.

Two mechanisms may be provided in system 10 to provide information to subscribers 60. In one instance, subscribers 60 can login or otherwise access healthcare information logic structure 20 through a query portal 25. Subscribers 60 can enter queries 26 into portal 25, which is interfaced with healthcare information logic structure 20. Logic structure 20 may properly gather and/or associate data from database 21 with master patient index 31 based on the parameters of query 26 and any access/information rules applicable to system 10. In another instance, subscribers 60 may be delivered direct notifications 27, such as via email or alert every time an ADT message 35 or other healthcare update occurs to a patient. As such, information flow through conventional HIE 15 is typically wholesale and in a single direction, from healthcare providers 50 to HIE 15, which serves as a clearinghouse and organizer for all healthcare information, and then to subscribers 60.

### SUMMARY

Example methods and embodiments manage healthcare information in computer-based networks between healthcare information sources. Example systems and methods are configured to receive several different types of information about patients based on healthcare events, such as admission flags, CCDA documents, clinical feeds, etc. from a healthcare provider like a hospital or clinic through a networked computer configured to interact with the healthcare provider IT. Example systems are configured to identify the patient that is the subject of the healthcare event based on the received information, and figure out how to contact the patient and/or a related party like a guardian, attorney, relative, etc. Example systems can include or be networked with databases or other information sources that describe such addressing information for the patients, such that example networks can reliably determine who and how to update. With that addressing information, when the received healthcare information reflects a serious healthcare event, like an admission or transfer or discharge at a hospital that requires alerting of other subscribing healthcare providers, insurers, governmental agencies, etc., the computerized system can update the patient or interested other party about the event and sharing of information. The update can be tailored to the identified addressee to give easily-understood information, based on their relationship with the patient. Such updating can be done in parallel with, or independent of, alerting subscribers about the healthcare information.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a related art health information exchange system.

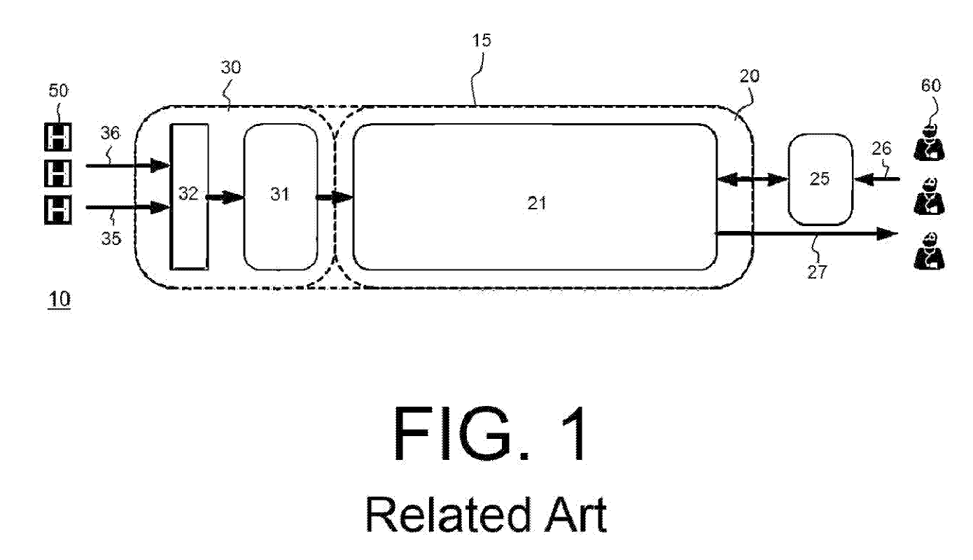

FIG. 2 is an illustration of an example embodiment healthcare notification system.

FIG. 3 is a flow chart illustrating an example method of healthcare information and notification processing and updating.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and “the” are intended to include both the singular and plural forms, unless the language explicitly indicates otherwise with terms like “only a single element.” It will be further understood that the terms “comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations. It should be presumed that any embodiment having features and functionality described below, in any workable combination, falls within the scope of example embodiments.

The following co-owned applications are incorporated by reference herein in their entireties: U.S. application Ser. No. 13/844,332 to Antony et al. filed Mar. 15, 2013; U.S. application Ser. No. 14/142,625 to Antony et al. filed Dec. 27, 2013; U.S. application Ser. No. 14/189,225 to Antony et al. filed Feb. 25, 2014; U.S. application Ser. No. 14/189,278 to Antony et al. filed Feb. 25, 2014; U.S. application Ser. No. 14/189,306 to Antony et al. filed Feb. 25, 2014; U.S. application Ser. No. 14/445,562 to Antony et al. filed Jul. 29, 2014; and U.S. application Ser. No. 14/872,445 to Antony et al. filed Oct. 1, 2015. Moreover, the example methods and embodiments of the incorporated documents are useable in whole and in part in addition to, or in replacement of, example systems and methods, including individual components, elements, structures, steps, connections, actions, data structures, functionalities, etc. thereof.

The inventors have recognized that existing healthcare notification systems do not have a method for accurately and consistently notifying patients and relevant third parties outside of the healthcare system, such as next-of-kin, emergency contacts, guardians, etc., when the patient experiences a healthcare encounter, and, more particularly, a healthcare encounter of such importance that healthcare providers are alerted about the encounter, especially in the case of admission to a healthcare facility. Patients are thus often unaware of the clinical significance of the healthcare encounter and whether other parties, such as other treating physicians, are aware of the encounter. Relevant third parties are similarly often unaware of the healthcare encounter, and there may be no way of identifying, let alone notifying, such third parties.

The present invention is computer networks, software, and/or hardware that receive healthcare information and selectively update others based on such receipt. The present invention is not—and the inventors and applicant explicitly disclaim—scope over a bare transitory signal or an abstract idea per se. While transitory signals and general concepts of arranging human behavior, comparing information and using rulesets based thereon, and categorizing information, are useable with or in the present invention, the present invention is limited to particular implementations of those signals and concepts in connection with or to improve existing healthcare computerized information technology. In contrast to the present invention, the few example embodiments and example methods discussed below illustrate just a subset of the variety of different configurations that can be used as and/or in connection with the present invention.

### Example Embodiments

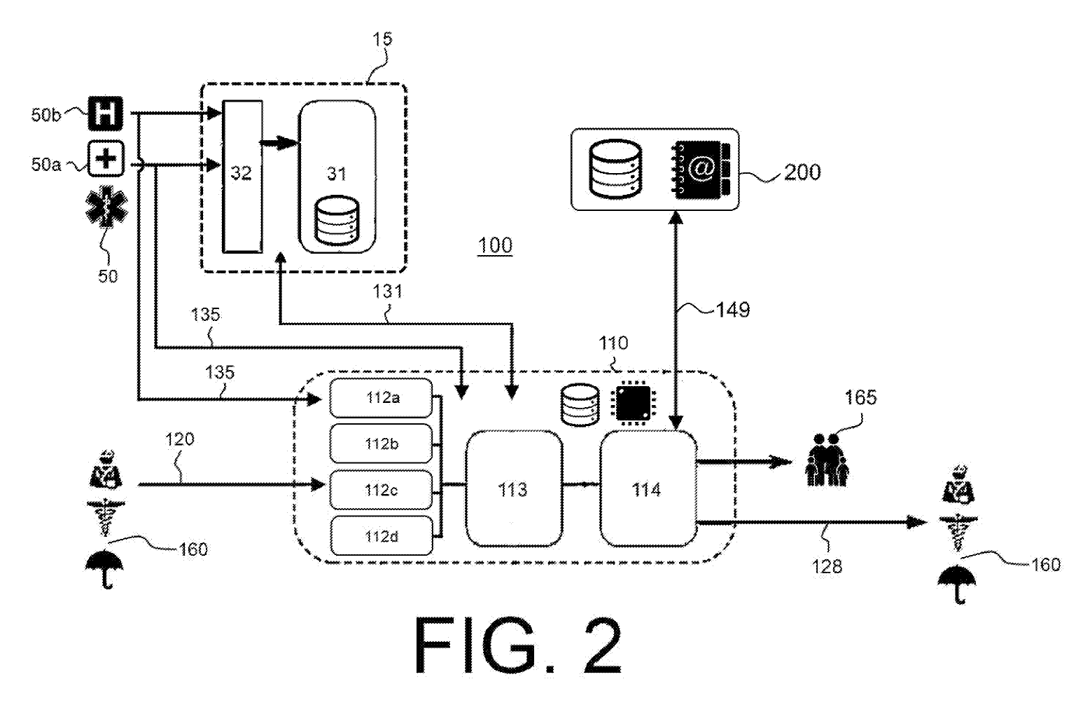

FIG. 2 is a diagram of an example embodiment healthcare notification system 100 that can be physically and logically configured through proper hardware infrastructure and/or software programming to provide targeted healthcare notifications and/or execute example methods of providing healthcare information. As shown in FIG. 2, example embodiment healthcare notification cluster 110 may be connected to a source of healthcare information, like a health information exchange (HIE) 15 and/or a healthcare provider 50 in example embodiment system 100. Healthcare notification cluster 110 and the source may be co-located or remote, and may be connected via a dedicated connection or bus in a same setting or over great distances through potentially shared networks such as VPNs, WANs, LANs, or the Internet, including TCP/IP and email exchanges.

Although example embodiment healthcare notification system 100 includes HIE 15 and/or actual providers 50 as healthcare information sources, it is understood that other types of sources for healthcare information are useable with example embodiments and methods. For example, a healthcare provider network system or other database having different data and interface configuration may be used in place of HIE 15. Still further, HIE 15 could be fully contained within healthcare notification cluster 110 to provide a centralized system for receiving, storing, processing, and/or delivering desired healthcare information to various subscribing providers 160. HIE 15 and providers 50, like a hospital or specialist clinic, may be equally be remote and operated by a distinct actor, such as a private corporation or state-operated database independent from cluster 110.

As shown in FIG. 2, healthcare notification cluster 110 is configured to receive subscriber information including subscriber parameters 120 from subscribing providers 160. Example embodiment healthcare notification system 100 is useable with a wide variety of subscribing entities 160 including both healthcare providers and other types of entities, including primary care physicians, specialists, insurance providers, hospitals, labs, clinics, home healthcare providers, government entities, researchers, etc. Subscribers 160 may really be any party who wants—or may be able to provide unique services with—specific healthcare information and notifications.

Subscriber parameters 120 define at least some services and/or actions to be provided by example embodiment system 100. For example, subscriber parameters 120 may include a roster of patient information—including patient name(s), hospital identifier, member ID, home address, city, state, zip code, date of birth, gender, ssn, phone numbers, membership status, family members, email addresses, etc. and/or portions thereof—identifying patients relevant to subscribers 160. For example, patient information submitted in parameters 120 may be associated with patients under the care of a primary care physician subscriber, covered by an insurance company subscriber, and/or under the jurisdiction of a governmental subscriber. Other subscriber information may also be transmitted separately and/or as a part of subscriber parameters 120, including subscriber name, type, service level, enterprise or tax identification numbers, delivery preferences, etc. described in greater detail below.

Subscriber parameters 120 may be input and/or updated into healthcare notification cluster 110 through a subscriber login interface, manually from delivered subscriber parameters 120 (such as from a spreadsheet via email), and/or automatically generated in cluster 110 based on a ruleset. For example, each subscribing provider 160 may provide subscriber parameters 120 to healthcare notification cluster 110 through any type of communication possible within a computer-processor-based network, including email, direct connection, manual input, etc. Subscribing providers 160 may provide multiple subscriber parameters 120 at signup and/or modify existing subscriber parameters 120, as their patients and needs and desires for healthcare information change.

Healthcare notification cluster 110 may include an input structure 112 to receive, process, and update/store information from subscriber parameters 120 in accordance with a transmission method used in example embodiment cluster 110. Input structure 112 may be, for example, a module or subroutine within healthcare notification cluster 110, a dedicated server with independent processing capability, and/or a common processor and database in notification cluster 110, depending on the configuration of healthcare notification cluster 110. In example embodiment healthcare notification cluster 110 of FIG. 2, several input structures 112a-d can be used, each with storage capability. Input structures 112a-d may be panels individualized to each subscriber 160; that is, each subscriber 160 may have a one-to-one assigned input structure 112x that stores subscription information, including subscriber parameters 120, only for the one assigned subscriber.

Subscriber parameters 120 stored by input structure 112 may include any kind of subscription information. As discussed above, subscriber parameters 120 may set out a roster of responsive client identifications. Subscriber parameters 120 may further delimit a variety of circumstances for which subscribing providers 160 desire healthcare information, including any combination of events or message types based on which to create notifications, frequency of notifications, delivery format, type preferences, etc. For example, parameters 120 may include a limiting set of events or circumstances for which subscribing providers 160 desire healthcare information. Further, subscriber parameters 120 may include healthcare information formatting, delivery options, analysis, and/or enhancement selections.

Example embodiment healthcare notification cluster 110 is interfaced with a healthcare information source. For example, cluster 110 may include an HIE interface 131 that is configured to communicate with healthcare information sources, such as MPI 31, HIE interface 32, and/or entire HIE 15. Or, for example, cluster 110 may include a provider connection 135 that is configured to communicate directly with providers 50, like hospitals, doctor's offices, pharmacies, home healthcare workers, clinics, etc. Thus, cluster 110, via logic core 113 and/or a separate interface, may recognize and understand how to retrieve, read, and/or write specific data structures or information association regimes present within MPI 31, such as client IDs, patient-identifying information, relationships among entries and records, etc., stored in MPI 31.

Similarly, cluster 110, via logic core 113 and/or a separate interface, may recognize and understand how to receive and process healthcare information directly from providers 50 transmitted via direct provider interface 132. As a specific example of healthcare information from a provider 50, a hospital 50 may generate a summary of care document(s) during a patient encounter, like a discharge. The summary of care document may include healthcare information like patient biographical information, insurance information, treatment information, health history, etc., and may be in a standard electronic health record format, like a Consolidated Clinical Document Architecture (CCDA) message. The CCDA message may be sent directly over interface 132, such as via email using Direct protocol or other HIPAA-compliant secure communications.

Of course, other information types can be transferred over interface 135, such as clinical feed information and/or all HL7 messages from providers 50, which may be thousands or more of HL7 messages per day including ADT-type messages. Cluster 110, via logic core 113, an intake module of direct provider interface 132, and/or another interface can recognize and be able to process information in specific data formats and information relationships sent directly from providers 50, including CCDA summary of care documents and ADT messages, for example.

Although interfaces 131 and 135 are shown as separate in FIG. 2, this is only to describe functionalities. It is understood that, with any interface, direct communications from providers 50 to cluster 110 may be achieved. For example, interface 131 may be directly accessed by providers 50 in HIE 15, such that provider 50 may still directly provide information to cluster 110. Similarly, HIE 15 may itself be wholly or part of a provider 50, and/or wholly or part of cluster 110, such that providers 50 and/or cluster 110 may assume all functionalities of HIE 15, either shared or exclusively. In these ways, a direct provider interface 135 may be a single interface 131.

Healthcare notification cluster 110 in example embodiment system 100 may also include a notification engine 114 controlled by logic core 113. As with each component of cluster 114, notification engine may be a functionality wholly programmed in logic core 113 or can be a separate module or even a remote server with its own processor and persistent and transient memory that is programmed or configured hardware to perform notification functionality in accordance with example methods or otherwise.

In view of this flexibility of cluster 110 and the necessarily computerized nature of HIEs and example embodiments and methods, as used herein, “logic core” and “(computer) processor” in cluster 110 are defined to include any and all computer hardware processor(s)—whether divided, remote, co-located, and/or singular—and any associated bus and memory that are configured through programming and/or hardware and structural connections to electronically communicate with healthcare IT systems including HIEs, intake and patient processing systems at healthcare providers, insurers' computer systems, and subscribers' computers. Given the thousands, if not millions, of healthcare encounters and transactions and associated pieces of healthcare information received daily and processed in example methods—including filtering, formatting, selective forwarding, and analysis of such data based on subscriber parameters and/or other stored data—it is further understood that logic core 113 must be sufficiently large and powerful to process such data and execute example methods in “real time”—i.e., instantaneous as perceived by a human user or at least within the timeframe of the task or action that triggers example methods.

Notification engine 114 can prepare healthcare notifications from data anywhere in system 100, such as data derived from ADT messages via interface 135, MPI 31, healthcare analysis stored in cluster 110, and/or any other healthcare information. Notification engine 114 may further provide the prepared information in a subscriber notification. Healthcare notifications may be delivered to subscribing providers 160 through a report 127 sent via email, over a direct or secure network, through the Direct standard, in HL7 format, via Internet services, or even hard copy, based on profile information 120 or other rules. Based on the method used, return receipt or other feedback on delivery of report 127 may be received in cluster 110. For example, under Direct protocols, a Direct email message sent to a subscriber 160 containing responsive information from a CCDA received and matched with the subscriber by cluster 110. The receiving subscriber 160 may send a return receipt, such as a Message Disposition Notification, back to the secure Direct email address of cluster 110 acknowledging receipt. Cluster 110 may store such acknowledgement and/or make it available to the original provider 50 that generated the CCDA that ultimately resulted in the notification 127 being sent.

Healthcare notifications may be structured as narratives, tables, spreadsheets, existing encounter formats, etc. by notification engine 114. For example, notification engine 114 may compile and email out a report of all healthcare information received, filtered, and/or formatted by logic core 113. Healthcare notifications may also be prepared and stored with notification engine 114 and provided to subscribing providers 160 only upon their access 128 to healthcare notification cluster 110; a reminder of a new healthcare notification may still be provided in this instance. Still further, a subscribing provider 160 may receive and/or acknowledge notifications via the Direct standard in real-time from notification engine 114, which may store or further process such acknowledgements.

Notification engine 114 may further include a contact interface 149 to permit cluster 110 to gather information from contact databases 200 about relevant third parties for patients for whom healthcare information is received. For example, notification engine 114 may gather and/or determine next-of-kin, an individual holding power of attorney, emergency contacts, legal guardian, and/or any other third party that may hold an interest in the status of a patient for whom healthcare information is received from providers 50 but is not a subscriber 160 or otherwise involved in the patient's healthcare. Contact database 200 may include a state motor vehicle database including all drivers' next-of-kin, a local property or marital database listing cohabitants or spouses, and/or donor registries, for example. Cluster 110 is configured through contact interface 149 to search, read, cross-reference and/or gather relevant third-party information from contact database, including providing proper credentials to access database 200.

Similarly, notification engine 114 may be configured to gather and/or logic core 113 may be configured to provide to notification engine 114, relevant third party information for patients from internal patient databases, subscriber parameters 120, healthcare information 135/131, and/or MPI 31. For example, emergency contacts or a power of attorney holder may be present in association with patients in an ADT message received from healthcare providers 50, and cluster 110 may match such emergency contacts and/or attorneys with a patient, in the same ADT or in healthcare information elsewise received.

Still further, notification engine 114 and/or logic core 113 may be configured to determine patient addressing from internal or external sources. For example, logic core 113 may determine a patient postal address from a received ADT message or a patient email address from a contact database 200 using received healthcare information 131/135 and/or subscriber parameters 120 for the patient. In this way, cluster 110 may determine how to contact a patient for whom healthcare information is received and potentially for whom an alert is generated to subscribers 160 to update the patient about the alert.

Because notification engine 114 and/or logic core 113 may determine addressing or other contact information for relevant contacts 165, such as next-of-kin, legal guardians, the patient itself, etc., an update may be provided to such contacts 165 at desired junctures, and even when contacts 165 are not subscribers 160 or otherwise requesting alerts, updates, or any other interaction with cluster 110. For example, notification engine 114 may send an email, generate and mail a postcard, send an SMS, make an automated telephone call, etc. to contacts 165 using determined addressing information for the contact relative to healthcare information received. Such updating may occur when an alert or notification is provided to subscribers 160, to make patients aware their information was shared or alert caregiving third parties of a patient's status, or at other junctures where an update to an otherwise non-requesting contact 165 is desirable to achieve positive healthcare outcomes.

As referenced above in connection with the flexibility of cluster 110, logic core 113 and any communications interface 131, 135, 127, 128, 149, etc. may be a central routine executed on specifically-configured processor networked to an electronic network, individual and distinct servers and routers with independent storage and processors potentially operating on diverse operating protocols, or any other hardware capable of performing electronic communication. Interfaces in example embodiment system 100 can be over the Internet, including standard communications protocols such as TCP/IP or email, and/or through a programmed application configured to interact with and exchange data in dedicated network or intranet. Servers within example embodiment system 100 may include, for example, conventional domain and/or security and encryption protocols for access and authentication as well as processing capacities to retrieve, deliver, and/or format data for use within example embodiment system 100.

Similarly, although networked elements of example embodiment system 100 are shown in FIG. 2 as individual components with specific groupings and subcomponents, it is understood that these elements may be co-located in a single device having adequately differentiated data storage and/or file systems and processing configurations. Alternatively, the elements shown in FIG. 2 may be remote and plural, with functionality shared across several pieces of hardware, each communicatively connected at adequate speeds to provide necessary data transfer and analysis, if, for example, more resources or better logistics are available in distinct locations. Given the variety of example functions described herein, healthcare notification cluster 110 may be structured in a variety of ways to provide desired functionality. Other divisions and/or omissions of structures and functionalities 112, 113, and 114 among any number of separate modules, processors, servers are useable with example embodiment system 100, including execution on a single machine or among distant, exclusive servers and processors.

Although the example embodiment system 100 of FIG. 2 is a computer-based system that can be configured with and execute example methods, it is understood that example methods are useable with other network configurations, and system 100 is useable with other methods of healthcare delivery.

### Example Methods

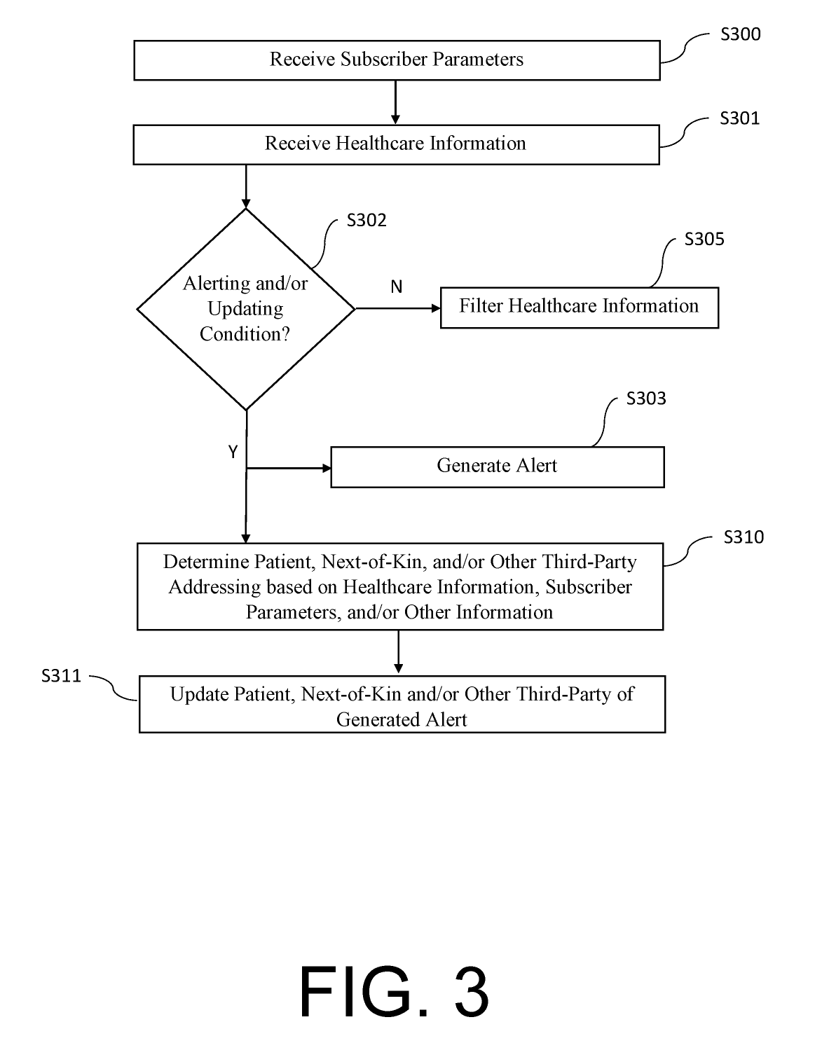

Based on healthcare information received from a healthcare information source and potentially subscriber parameters received from a subscriber, a computerized healthcare notification engine can collect, compile, enhance, analyze, and/or provide specific and well-tailored healthcare notifications to subscribers. In the context of FIG. 2, healthcare notification cluster 110 includes a logic core 113 interfaced with and/or controlling operation of HIE 15 as well as interfaced directly with providers 50. Logic core 113 may coordinate actions of example methods, including healthcare message processing and analysis, retrieval of healthcare information, delivering healthcare information in accordance with subscriber parameters, delivering notification alerts to relevant patients and third-parties, enhancement of MPI 31, and/or several other functions discussed further herein. FIG. 3 is a flow chart illustrating an example method of healthcare information and notification processing. Using an example network 100 from FIG. 2, logic core 113 may provide healthcare message processing in the example method of FIG. 3. As such, while an example method is described in connection with FIG. 3, it is understood that structures and reference characters executing the same may refer back to FIG. 2.

As shown in FIG. 3, in S301, subscriber parameters 120 are received from one or more subscribing providers 160. S300 may be executed before, after, and/or in real time with other actions in example methods, such that subscriber parameters 120 may be updated whenever, automatically or at a discretion of a subscriber 160 or other ruleset or actor. In S301, receiving subscriber parameters 120 may further include processing and/or storing such parameters by an input structure 112, such as in input structure/panel 112b associated with the subscriber 160.

In S301, healthcare information is received from a source. For example, incoming notifications/information to HIE 15 may be monitored and/or received by healthcare notification cluster 110 through interface connection 131. Incoming messages may include standard or enhanced ADT messages 35, CCDA documents, and/or other information from clinical feeds 36, for example. In S301, several messages from several different sources may be received, and receiving S301 may include processing and/or storing received healthcare information, for example, to extract relevant patient data and/or decrypt or arrange data therein based on message type and source configuration. Although the default rule for all actions, S301 and S300 may occur in any order, given proper persistence of subscriber information and healthcare information in a network executing an example method.

In S302, treatment of the received healthcare is determined, including whether to generate an alert based on the same. For example, the received healthcare information in S301 and received subscriber parameters in S300 are compared to determine further treatment of the information. For example, in S302, logic core 113 may compare a patient identifier in a received ADT message 35 against client-identifying information, such as a name, address, patient ID, birthdate, SSN, etc. and/or portions thereof, from a roster processed by input structure 112 from client parameters 120 so as to identify messages relating to a responsive client, e.g., one in a roster from a subscriber. Logic core 113 may thus determine which messages are responsive to a provider's roster based on the comparison in S302. Further, because partial information and several different types of healthcare information may be compared in S302, partial or some incorrect information being present in ADT message 35 or picked up from MPI 31 or incorrectly input into a clinical feed 36 may not prohibit a proper match between received healthcare information and with subscription parameters 120.

In S303, if there is a match from the comparison of S302 or another indicated alerting condition, the matching received information, potentially corrected and/or enhanced from other information as discussed in the incorporated documents, can be prepared for, forwarded to, or otherwise alerted about to matching subscribers. If there is not a match in S302 or subscriber parameters indicate so, the received information may be filtered out in S305, by being discarded or otherwise held without alert and/or being forwarded to a subscriber. Or for example, logic core 113 may process received healthcare information to discard messages or portions of information containing duplicate, incorrect, or low-value contents in S305. Several different matching criteria and alerting conditions are discussed in the incorporated documents as examples of when an alert is generated in S303 and not generated in S305, such that subscribers and other interested parties are selectively fitted with only well-matched alerts from the likely thousands of pieces of healthcare information received each hour in any network.

The indication of an alerting condition in S302 causes delivery of an alert update to another party in S311. Such other parties may include the patient who is the subject of the healthcare information received in S301, an emergency contact of the patient, a next-of-kin of the patient, an appointed attorney of the patient, a co-habitant, and/or any other party that may be interested in knowing that the patient has suffered an alerting condition and/or that the patient's information has been shared via the alert in S303. In this way, a patient may be updated that a subscriber, such as another healthcare provider, an insurer, a parole officer, a government recordkeeper, their specialist, etc., has been alerted about their admission, transfer, or discharge. This may save the patient time in that they no longer need to contact such parties and/or may facilitate healthcare compliance by the patient who now knows that other providers and/or parties are aware of the triggering healthcare information of the patient. Similarly, an interested third-party, such as a family member, representative, or caretaker can be updated about the alerting condition and better respond to the patient's family and/or estate needs.

Updates about the generated alert must be properly matched and delivered to relevant parties in S311. Thus, the identity and/or addressing of such relevant third parties may be determined in S310 from a variety of sources. For example, an external public or proprietary database may be accessed in S310 to determine patient relevant third party identify and/or addressing. For example, a Department of Motor Vehicles database 200 may store all driver next-of-kin information and/or emergency contact information, and cluster 110 may access such data, potentially through proper authentication or other access controls, to match known patient information with driver emergency contacts' information. Or, for example, a county deed registry database 200 or marital database 200 may be similarly accessed to determine other individuals names and contact information either living with or married to the patient. As even further examples, an emergency medical contact system 200, online phone number directory 200, and/or criminal database 200 may all be used to determine emergency contacts and/or representing officers that correlate with the patient in the healthcare information triggering the alerting condition.

Or, for example, an internal database or derived information may be used in S310 to determine patient relevant third party identity and/or addressing. For example, if the received healthcare information in S310 is an HL7 ADT message that triggers an alert in S302 by reflecting an admission of a patient identified in subscriber parameters, that HL7 ADT message, as well as subscriber parameters for that patient may be searched for emergency contacts or other pertinent third-parties. Similarly, a database in cluster 110 may be maintained associating third-party addressing for all patients identified in received patient parameters, gathered over time from internal and/or external sources. Or, for example, cluster 110 may access next-of-kin information or relative information from MPI 31 that matches a patient in an alerting condition.

All sources may be used together in S310 to determine multiple relevant third parties, determine addressing for the same, and ensure correctness of addressing. For example, while a received CCDA document 135 causing an alerting condition may only list a patient's insurance ID due to lack of patient responsiveness in a healthcare scenario, that insurance ID may be matched against subscriber parameters 120 associating that insurance ID with a patient name and address. The determined patient name may then be referenced against a public database 200 of known names and addresses in nearby communities, generating another name of a person, perhaps a spouse or relative, living at the same address. This information may be paired to determine a proper mailing or physical address for a next-of-kin in S310. Of course, several other different combinations of information pieces from relevant information sources, including governmental, proprietary, and public databases, may be used for cross-referencing, matching, and verifying correct addressing information in S310.

While S310 is shown as occurring only in the instance of an alerting condition, such logic is only for efficiency. Determination of relevant third party or patient information in S310 may occur at any time, such as each time a parameter or piece of healthcare information is received in S300 or S301. Such determinations may be stored in cluster 110, HIE 31, or any other repository that associates the third-party or patient addressing information with alerting conditions for that patient. Similarly, determined addressing information in S310 may be updated or corrected with incoming parameters, information, and/or accessing third-party addressing information such as database 200 in order to assure that best patient contact information and/or best interested third-party identity and addressing is known and useable in example methods.

In S311, an update of the alerting condition is generated and sent to the address determined in S310. For example, in FIG. 2, notification engine 114 or another component of cluster 110 sends a notification to interested party 165 in response to receipt of healthcare information (such as over interfaces 135 or 131) that triggered an alert in cluster 110. The interested party 165 is matched in both identity and addressing to the triggering information in cluster 110, such that only correctly-corresponding and properly-addressed updates are generated in S311. In S311, the interested party may be the patient itself, who is thus made aware that a separate alert has been sent to subscribers and/or providers in S303. Or, for example, in S311, the interested party may be an emergency contact, a next-of-kin, a guardian, a legal representative, a responsible officer, a co-habitant, a spouse, etc.

The update may take on any format and include a variety of information. For example, the update may be as simple as “An alert was generated for [patient identity].” The update may also include information from (or outright forward) the healthcare information and/or another database like MPI 31, database 200, and/or cluster 110, such as “[Name] was admitted to [hospital name in healthcare information] for [alerting condition] on [date of healthcare information].” The update may be customized based on recipient. For example, if the recipient is the patient, it may read “Your healthcare information was shared in an alert to subscribers”; or, if the interested third-party is determined to be an emergency contact, the update may present information along the lines of “You are listed as an emergency contact for [Patient identity], who was admitted to [hospital from healthcare information].” In this way, updates may be relatively easy to understand based on their recipient and not necessarily as detailed or medically technical as the alert generated in S303 or the healthcare information received in S301. This may allow recipients of updates to best understand the alerting condition and take appropriate, potentially immediate action based on the altering condition. For example, an attorney may meet the patient/client to (re-)draft a will based on a life-threatening alerting condition, a parent may pick up a child based on a discharge alerting condition, and/or the patient may be updated that its treating physician knows about an emergency room admission for a relevant condition.

Updates may be transmitted in any manner in S311, potentially based on addressing information. For example, if addressing information determined in S310 is a postal or physical address, the update generated in S311 may be a postcard bearing the update information. Or, for example, the update may be an email or SMS alert sent to an email address or telephone number of a next-of-kin determined in S310. Still further, a dedicated connection or online interface may be used to receive or log-in and receive updates for relevant third parties and/or the patient. Updates in S311 may be sent in real-time, such as nearly instantaneously with receipt of healthcare information in S301 at a speed only possible with computer automation of condition detection, addressing determination, and update generation. Alternatively, updates in S311 may be delayed, such as a default delay time to avoid over-complication of medically critical situations or based on the healthcare information, such as a delay in notifying a doctor or next of kin until a discharging healthcare information is received in S301.

Although in FIG. 3 a single condition is shown as determined in S302 to generate an alert in S303 in combination with an update in S311, it is understood that alerts and updates may not be so aligned. An alerting condition determined in S302 may not always trigger an update in S311 and vice versa. For example, there may be an additional filter or triggering requirement for updates in S311, such as a required level of significance or uniqueness for an update to the patient or interested third-party, so that updates are not reporting low-value information or repetitive. Similarly, for example, alerts may not be generated in S303 due to additional subscription filters, lack of matching, and any of the various limitations on alerting found in the incorporated documents; in this instance, updates in S311 may still be generated in response to an alerting condition S302, even if the ultimate alert is never sent. Of course, if a patient is to be notified in S311 only in the instance that an alert is generated in S303, such as for compliance with information-sharing regulations or patient request, then S303 and S311 may both be mandatory to effect this requirement. Patients and third-parties may also opt-in or opt-out of receiving updates in S311 (such as by return SMS or through patient intake forms, for example), such that updates in S311 may not exist when alerting occurs in S303. Of course, multiple updates to several different parties may correspond to a single alerting condition, just as multiple alerts to several different subscribers may generate only a single update to a patient or interested third-party.

This paragraph offers an example of S300-S311 taken together. Hundreds of thousands of electronic messages, clinical feed data, ADTs, CCDAs, etc. in various formats including HL7 are received at cluster 110 for thousands of different patients from hundreds of different sources each day, including healthcare providers 50 and/or state-operated HIE 15. A programmed computer processor in cluster 110 processes each piece of this deluge of healthcare information, identifying and/or storing clinically-relevant information in correct association with each patient treated. Eventually, an admit-type ADT message in HL7 standard is received from a flagship hospital emergency room 50b for patient John Doe in cluster 110. In real-time, while the emergency room 50b is still processing patient John Doe for treatment, cluster 110 pulls the spouse 165 of patient John Doe from a county marital registry 200, using John Doe's full name and address from a subscriber parameter 120 that matched the ADT to find the spouse. Cluster 110 then updates John Doe's spouse 165 using a telephone number in the marital registry of the admission, using hospital information from the ADT message. Cluster 110 also sends an update to John Doe himself the next day, based on an a home address listed in the ADT message, as a postcard indicating that his admission caused his status to be shared with his spouse and alerted to his insurer. These updates are provided while multitudinous other pieces of healthcare information are received at cluster 110, each with unique handling.

It is understood that example methods may service any number of distinct providers 50 and/or HIEs 15, including entire community-or-jurisdiction-level populations with hundreds of providers and millions of patients. Example methods are necessarily computerized, and, indeed, the only way to compare all, numerous received pieces of electronic healthcare information in S303 for alerting conditions across any reasonable healthcare population is with a programmed and significantly-powered computer processor and memory. As such, the present invention is strictly computerized and significantly limited to implementations that are highly involved with, and improve the function of, computerized healthcare IT.

As with all healthcare information sharing among separate parties, appropriate safeguards—including encryption, encoding, and/or communications protocols like HL7 and Direct—may be placed on any interface and transmission in example embodiments and methods. It is understood that Direct and HL7 protocols are defined by their standard-setting bodies, explained at http://wiki.directproject.org/ and http://www.hl7.org/implement/standards, with current and future editions of these standards included in the terms “HL7” and “Direct.” As an example of Direct protocol, “Applicability Statement for Secure Health Transport,” version 1.2, Aug. 3, 2015 is incorporated herein in its entirety by reference. Similarly, because providers 50, HIEs 15, subscribers 160, cluster 110, and third-parties/patients 165 can all be distinct actors with independent owners and operators with distinct interests in healthcare information, appropriate consents and HIPAA-compliant releases may be secured or required from each independent party before any information exchanging or usage is executed in any example method.

Some example methods being described here and in the incorporated documents, it is understood that one or more example methods may be used in combination and/or repetitively to produce multiple options and functionalities for subscribers. Example methods may be performed by properly programming or hardware configuring notification networks to receive healthcare information and subscriber information and act in accordance with example methods. Similarly, example methods may be embodied on non-transitory computer-readable media that directly instruct computer processors to execute example methods and/or, through installation in persistent memory, configure general-purpose computers connected to subscribers and healthcare information sources into specific healthcare notification networks that execute example methods.

Example methods and embodiments thus being described, it will be appreciated by one skilled in the art that example embodiments may be varied through routine experimentation and without further inventive activity. For example, although. Variations are not to be regarded as departure from the spirit and scope of the exemplary embodiments, and all such modifications as would be obvious to one skilled in the art are intended to be included within the scope of the following claims.

What is claimed is:

1. A method of managing healthcare information with a notification system electronically networked with a healthcare information source, the method comprising:
electronically receiving healthcare information about a patient from the healthcare information source;
determining, with a computer processor in the notification system, addressing information for the patient or a third party interested in the patient; and
providing, with the computer processor in the notification system, an update about the patient to the third-party at the addressing information if the healthcare information indicates an alerting condition of the patient, wherein the providing is not executed if the healthcare information does not indicate an alerting condition.

2. The method of claim 1, further comprising:
receiving subscriber parameters identifying a plurality of patients from a plurality of subscribers, wherein the third-party is not a subscriber and has not provided subscriber parameters.

3. The method of claim 2, further comprising:
alerting each subscriber of the plurality of subscribers whose subscriber parameters include the patient in the healthcare information.

4. The method of claim 3, wherein the third party is the patient, and wherein the update indicates that the alerting occurred.

5. The method of claim 1, wherein the third party interested in the patient is at least one of an emergency contact of the patient, a next-of-kin of the patient, and a guardian of the patient.

6. The method of claim 1, wherein the determining the addressing information includes accessing a database including the addressing information stored in connection with the patient.

7. The method of claim 6, wherein the database is a third-party database owned and operated independently from the computer processor.

8. The method of claim 7, wherein the third party interested in the patient is an emergency contact, and wherein the database is a department of motor vehicles database associating the patient with the emergency contact.

9. The method of claim 1, wherein the healthcare information is an HL7 ADT message, and wherein the determining the addressing information uses information in the ADT message.

10. The method of claim 9, further comprising:
receiving a plurality of subscriber parameters from a plurality of subscribers, wherein the alerting condition is based on the subscriber parameters, and wherein the determining the addressing information further uses information in the subscriber parameters.

11. The method of claim 1, further comprising:
if the healthcare information does not indicate an alerting condition of the patient, discarding the healthcare information.

12. A method of managing healthcare information in a healthcare network, the method comprising:
receiving, at the healthcare network, subscriber parameters identifying a plurality of patients from a subscriber;
electronically receiving, at the healthcare network, a plurality of ADT messages in the HL7 standard from a computerized healthcare information source;
determining, with a computer processor in the healthcare network, which of the ADT messages match patients from the parameters;
for each ADT message that matches a patient based on the determining, providing, with the computer processor in the healthcare network, a healthcare notification to the subscriber, wherein the healthcare notification identifies the matching patient, and wherein the providing is not executed for ADT messages that do not match patients based on the determining; and
for each healthcare notification provided to a subscriber, providing, with the computer processor, an update to a non-subscriber, wherein the update reflects the receipt of the ADT message.

13. The method of claim 12, wherein the non-subscriber is the patient, and wherein the update indicates that the providing the healthcare notification occurred.

14. The method of claim 13, further comprising:
determining addressing information for the patient from at least one of the ADT message, the subscriber parameters, and an outside database.

15. The method of claim 12, further comprising:
determining addressing information for the non-subscriber from at least one of the ADT message, the subscriber parameters, and an outside database.

16. The method of claim 15, wherein the non-subscriber is an emergency contact, and wherein the outside database is a department of motor vehicle database associating the patient with the emergency contact.

17. A computer processor networked with a plurality of healthcare providers, wherein the computer processor is configured to:
electronically receive healthcare information about a patient from the healthcare information source;
determine addressing information for the patient or a third party interested in the patient; and
provide an update about the patient to the third-party at the addressing information if the healthcare information indicates an alerting condition of the patient, wherein the providing is not executed if the healthcare information does not indicate an alerting condition.

18. The computer processor of claim 17, wherein the computer processor is further configured to,
alert each subscriber of the plurality of subscribers whose subscriber parameters include the patient in the healthcare information.

19. The computer processor of claim 18, wherein the third party is the patient, and wherein the update indicates that the alerting occurred.

20. The computer processor of claim 17, wherein the third party interested in the patient is at least one of an emergency contact of the patient, a next-of-kin of the patient, and a guardian of the patient.
